(19) United States
(12) Patent Application Publication
(10) Pub. No.: US 2017/0103101 A1
(43) Pub. Date: Apr. 13, 2017

(54) SYSTEM FOR DATABASE DATA QUALITY PROCESSING

(71) Applicant: TELOGIS, INC., Aliso Viejo, CA (US)

(72) Inventor: Ralph James Mason, Christchurch (NZ)

(21) Appl. No.: 15/288,195

(22) Filed: Oct. 7, 2016

Related U.S. Application Data
(60) Provisional application No. 62/238,308, filed on Oct. 7, 2015.

(51) Int. Cl. G06F 17/30; G07C 5/08; G07C 5/00

(52) U.S. Cl. CPC G06F 17/30371; G06F 17/30557; G06F 17/3053; G06F 17/30595; G07C 5/008; G07C 5/0808

(57) ABSTRACT

In an embodiment, a system can determine potential data quality issues in a database. The system applies quality assignment rules to a data set. The quality assignment rules access data from the data set or calculate one or more values from data entries of the data set. Data entries or determined values that satisfy the quality assignment rules receive one or more scores. The system then presents a subset of the data set based on the determined one or more scores. Accordingly, a user of the system can determine the source of the data quality issues such as a broken or miscalibrated data gathering device.

### RELATED APPLICATIONS

Any and all applications for which a foreign or domestic priority claim is identified in the Application Data Sheet as filed with the present application are hereby incorporated by reference under 37 CFR 1.57.

### BACKGROUND

In the context of a database, a human analyst may review data for quality and accuracy to determine data quality issues.

### SUMMARY

In some embodiments, a system is disclosed for determining data quality issues in a database. The system can include: a computer hardware processor in a physical computing device. The computer hardware processor being configured to: receive a data set comprising first data and second data; apply a first quality assignment rule to the first data to determine: (i) that a first value corresponding to the first data exceeds a first threshold, and (ii) a first score for the first data; apply the first quality assignment rule to the second data to determine: (i) that a second value corresponding to the second data exceeds a second threshold, and (ii) a second score for the second data; apply a second quality assignment rule to the first data to determine: (i) that a third value corresponding to the first data exceeds a third threshold, and (ii) an updated first score, from the first score, for the first data; apply the second quality assignment rule to the second data to determine that a fourth value corresponding to the second data does not exceed the third threshold; determine a subset of the data set based at least on the updated first score and the second score, wherein the subset of the data set does not include the first data; and cause presentation, in a user interface, of the subset of the data set.

The system of the preceding paragraph can include one or more of the following features: The data set can include vehicle telematics data. The computer hardware processor can be configured to determine the first value from a calculation of the first data according to the first quality assignment rule. Applying the first quality assignment rule can include a determination, from the first data, of at least one of: a speed, a time, a distance, a mass, a weight, an electric current, a temperature, or a luminous intensity. Applying the first quality assignment rule can include a determination, from the first data, of at least one of: a driving speed, a driving time, an idle time, an amount of fuel, or a GPS coordinate. Determining the subset of the data set can further include: receiving a first data quality level; determining that the updated first score does not correspond to the first data quality level; determining that the second score corresponds to the first data quality level; and generating the subset of the data set from the second data. Applying the second quality assignment rule to the first data can determine a third score, and the computer hardware processor can be further configured to: determine the updated first score by adding the first score and the third score. Applying the first quality assignment rule to the first data can determine the first value, the first value can correspond to a driving distance divided by a driving time, and the first threshold can correspond to a speed threshold. The first value can correspond to an idle time from the first data, and the first threshold can correspond to an idle time threshold. The first value can correspond to a fuel usage measurement from the first data, and the first threshold can correspond to a fuel usage threshold. Applying the first quality assignment rule to the first data can determine the first value, the first value can correspond to a driving distance divided by a fuel usage measurement, and the first threshold can correspond to a distance per fuel unit threshold. The computer hardware processor can be further configured to select, from a plurality of thresholds, the first threshold based at least on a vehicle type that corresponds to the first data. The first threshold and the second threshold can be the same threshold value, and the first score and the second score can be the same score value.

In some embodiments, a method is disclosed for determining data quality issues with fleet vehicle operation information. The method can include: receiving vehicle telematics data, the vehicle telematics data comprising first data and second data, the first data corresponding to a first vehicle and the second data corresponding to a second vehicle; applying a first quality assignment rule to the first data to determine: (i) that a first value corresponding to the first data exceeds a first threshold, and (ii) a first score for the first data; applying the first quality assignment rule to the second data to determine: (i) that a second value corresponding to the second data exceeds a second threshold, and (ii) a second score for the second data; applying a second quality assignment rule to the first data to determine: (i) that a third value corresponding to the first data exceeds a third threshold, and (ii) an updated first score, from the first score, for the first data; applying the second quality assignment rule to the second data to determine that a fourth value corresponding to the second data does not exceed the third threshold; determining a subset of the vehicle telematics data based at least on the updated first score and the second score, wherein the subset of the vehicle telematics data does not include the first data; and causing presentation, in a user interface, of the subset of the vehicle telematics data.

The method of the preceding paragraph can include one or more of the following features: The method can further include: determining the first value from a calculation of the first data according to the first quality assignment rule. Applying the first quality assignment rule can include a determination, from the first data, of at least one of: a speed, a time, a distance, a mass, a weight, an electric current, a temperature, or a luminous intensity. Applying the first quality assignment rule can include a determination, from the first data, of at least one of: a driving speed, a driving time, an idle time, an amount of fuel, or a GPS coordinate. Applying the second quality assignment rule to the first data can determine a third score, and the method can further include: determining the updated first score by adding the first score and the third score. Applying the first quality assignment rule to the first data can determine the first value, the first value can correspond to a driving distance divided by a driving time, and the first threshold can correspond to a speed threshold. The first value can correspond to an idle time from the first data, and the first threshold can correspond to an idle time threshold. The first value can correspond to a fuel usage measurement from the first data, and the first threshold can correspond to a fuel usage threshold. Applying the first quality assignment rule to the first data can determine the first value, the first value can correspond to a driving distance divided by a fuel usage measurement, and the first threshold can correspond to a distance per fuel unit threshold. The method can further include: selecting, from a plurality of thresholds, the first threshold based at least on a vehicle type that corresponds to the first data. The first threshold and the second threshold can be the same threshold value, and the first score and the second score can be the same score value. Determining the subset of the vehicle telematics data can further include: receiving a first data quality level; determining that the updated first score does not correspond to the first data quality level; determining that the second score can correspond to the first data quality level; and generating the subset of the vehicle telematics data from the second data.

In some embodiments, a system is disclosed for processing and presenting fleet vehicle operation information. The system can include a computer system comprising computer hardware configured to: receive vehicle telematics data for a plurality of vehicles in a fleet of vehicles, the vehicle telematics data comprising measurements related to operation of the plurality of vehicles; assign a first quality value to a first set of the measurements according to quality assignment rules; assign a second quality value different from the first quality value to a second set of the measurements different from the first set according to the quality assignment rules, the second quality value being associated with lower quality than the first quality value, the first set providing information about a vehicle of the plurality of vehicles during a first time period and the second set providing the information about the vehicle during a second time period different from the first time period; and in response to a user input corresponding to the information, output the first quality value and the second quality value for presentation on a display to a manager of the fleet of vehicles so that (i) the first quality value is displayed in association with the first time period and (ii) the second quality value is displayed in association with the second time period.

The system of the preceding paragraph can include one or more of the following features: The first quality value can be displayed in association with the first time period and the second quality value can be displayed in association with the second time period such that quality associated with the information is displayed as a plot over time on the display. The computer system can be configured to: assign a first indicator to the first set according to the quality assignment rules, the first indicator comprising a description of a reason that the first quality value was assigned to the first set; and in response to the user input corresponding to the information, output the first indicator for presentation on the display so that the first quality value is displayed in association with the first indicator. The computer system can be configured to: assign the first quality value to a third set of the measurements different from the first set and the second set according to the quality assignment rules; assign a first indicator to the first set according to the quality assignment rules, the first indicator comprising a description of a reason that the first quality value was assigned to the first set; assign a second indicator different from the first indicator to the third set according to the quality assignment rules, the second indicator comprising a description of a reason that the first quality value was assigned to the third set; in response to a user input corresponding to the first set, output the first indicator for presentation on the display so that the first indicator is displayed in association with the first quality value; and in response to a user input corresponding to the third set, output the second indicator for presentation on the display so that the second indicator is displayed in association with the first quality value. The computer system can be configured to, in response to a user input requesting display of the measurements associated with higher quality, output the first set and not the second set for presentation on the display. The computer system can be configured to, in response to a user input requesting display of the measurements associated with lower quality, output the second set and not the first set for presentation on the display. The quality assignment rules can include a plurality of rules, and the computer system can be configured to: according to the quality assignment rules, assign the first quality value to the first set in response to determining that the first set satisfies each of the plurality of rules; and according to the quality assignment rules, assign the second quality value to the second set in response to determining that the second set does not satisfy at least one of the plurality of rules. A rule of the plurality of rules can include a check as to whether an idle time exceeds an idle threshold, and when the idle time exceeds the idle threshold, the rule is deemed not to be satisfied. A rule of the plurality of rules can include a check as to whether a driving distance divided by a driving time exceeds a speed threshold, and when the driving distance divided by the driving time exceeds the speed threshold, the rule is deemed not to be satisfied. A rule of the plurality of rules can include a check as to whether a location distance between a starting location and an ending location exceeds a distance travelable within a driving period at a driving speed, and when the location distance exceeds the distance travelable, the rule is deemed not to be satisfied. Each of at least some of the quality assignment rules can include a check as to whether at least some of the measurements satisfy a threshold. When the at least some of the measurements satisfy the threshold, the at least some of the measurements are deemed to be of a lower accuracy than when the at least some of the measurements do not satisfy the threshold. When the at least some of the measurements satisfy the threshold, the at least some of the measurements are deemed to be of a lower precision than when the at least some of the measurements do not satisfy the threshold. The first quality value can be displayed in association with the first time period and the second quality value can be displayed in association with the second time period such that the manager is enabled troubleshoot quality issues with one or more components that generated the measurements.

In some embodiments, a non-transitory computer storage medium for storing computer executable instructions that when executed by a computer hardware processor perform operations of any of the preceding paragraphs.

### BRIEF DESCRIPTION OF THE DRAWINGS

The features of various embodiments disclosed herein are described below with reference to the drawings. Throughout the drawings, reference numbers are re-used to indicate correspondence between referenced elements. The drawings are provided to illustrate embodiments described herein and not to limit the scope thereof.

FIG. 1 illustrates an example computing environment including a vehicle management system and in-vehicle devices.

FIG. 2 illustrates an example in-vehicle device.

FIG. 3 illustrates an example data quality service.

FIG. 4 illustrates an example quality assignment and display process.

FIG. 5 illustrates an embodiment of a user interface for presenting data quality information to a user.

FIG. 6 illustrates another example quality assignment process.

FIG. 7 illustrates example quality assignment rules.

FIGS. 8A-8D illustrate example representations of vehicle data.

FIG. 9 illustrates an embodiment of a user interface for using processed or generated quality data.

### DETAILED DESCRIPTION

### I. Data Quality Processing

Data gathered from one or more physical devices and stored in a database may have data quality issues. For example, a physical device may be broken or miscalibrated and may transmit erroneous data. Advantageously, the systems, methods, and techniques described herein may automatically determine potential data quality issues with one or more predetermined quality assignment rules.

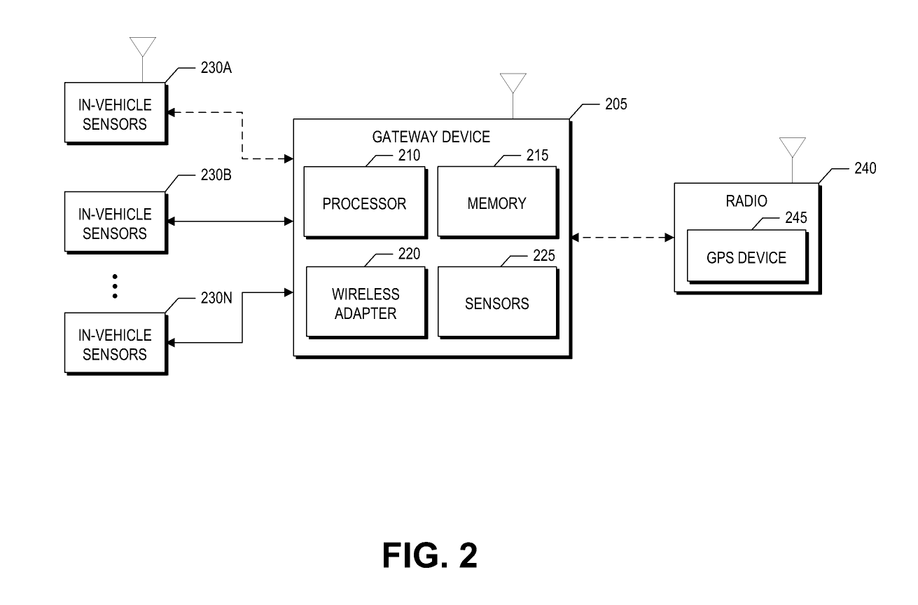

In a vehicle context, the accuracy or precision of measurements from a vehicle or a device (for instance, a sensor) associated with the vehicle can vary significantly depending on a source, timing, sophistication, or the like for the measurements. To facilitate a better understanding of the accuracy or precision of the measurements, the measurements or values thereof can be assigned one or more quality indicators (sometimes referred to as quality scores or trust scores) that correspond to the level of quality for the measurements or the values thereof. One quality indicator can be, for example, an assigned quality value selected from multiple quality values. This assignment can be based on the estimated accuracy of the measurements or telematics information, estimated reliability of this information, estimated feasibility of this information, source of this information, age of this information, precision of this information, or the like. The quality indicator can enhance the ability of an individual or vehicle management system to troubleshoot quality issues with the one or more measurements, the values thereof, a component of a vehicle, the telematics-generating components (such as the gateway and related components; see FIG. 2), or of the vehicle management system itself, by providing potentially valuable information regarding what may have caused a quality decrease or increase.

One or more measurements from a vehicle can be assigned different quality indicators over time as a quality of the one or more measurements varies over time. An example quality indicator is a quality score. In one example, a sensor or processor associated with a vehicle may measure a period of time that the vehicle remains in an idle state (where the engine of the vehicle is running but the vehicle is not moving). The sensor or processor can initially provide accurate measurements of the period of time that the vehicle remains in the idle state. However, after frequent use or over an extended duration of time, the sensor or processor may malfunction, become miscalibrated, or the like such that the sensor or processor provides less accurate measurements of the period of time that the vehicle remains in the idle state. As a result, a period of time measured by the sensor or processor during the initial time be assigned a quality score indicating a high quality and can be assigned a quality score indicating a low quality after the frequent use or over extended duration of time. If the malfunction or miscalibration of the sensor or processor may be addressed and corrected, a period of time measured by the sensor or processor can again be assigned the quality score indicating the high quality.

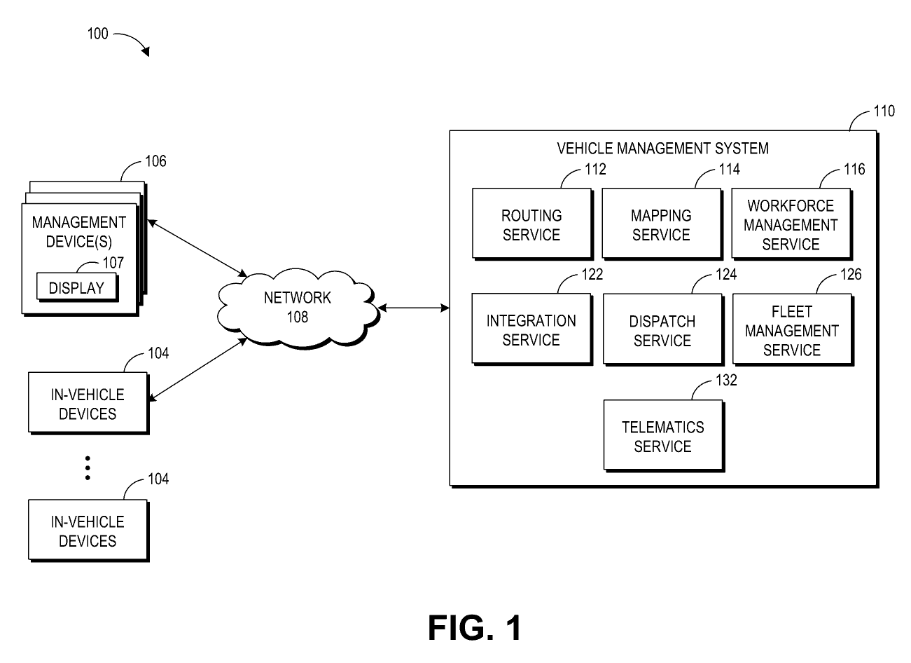

The assignment of the quality score to measurements or values of the measurements can be performed by the vehicle management system 110 of FIG. 1 (described in greater detail below) in some implementations. The telematics service 132 of the vehicle management system 110 can, for instance, apply heuristics, such as a set of rules, for automatically assigning a quality score to the measurements or values of the measurements. The heuristics when performed can facilitate a check on the measurements that the measurements provide realistic (for example, within usual ranges) or feasible (for example, within physical capabilities of a vehicle or a driver of the vehicle) values indicative of operation of a vehicle. When the measurements are deemed to provide realistic or feasible values, the heuristics can result in assignment of a relatively higher quality score, and when measurements are deemed to provide less realistic or feasible values, the heuristics can result in assignment of a relatively lower quality score. For example, if the gathered data erroneously reports a vehicle was traveling one thousand mile per hour, then the gathered data automatically receives a very low quality score, such as a do not trust score. On the other hand, if the gathered data reports that a commercial shipping vehicle was traveling, on average, eighty-five mile per hour, then the gathered data automatically receives a medium or moderate quality score. The quality score can thus provide a measure of a degradation or improvement in telematics data or a data generating component (for example, a vehicle sensor). The assignment of the quality score to the measurements or the values thereof can be performed periodically or randomly or triggered (for instance, when a change in values of measurements exceeds a threshold or when one or more other measurements receive a demotion in assigned quality score).

In one implementation, one or more measurements or values thereof can initially be assigned a default quality score (for example, a score indicative of a high, medium, or low quality). Heuristics can then be performed on the one or more measurements to assess a quality of the values. As the one or more measurements satisfy particular rules of the heuristics, the quality score assigned to the one or more measurements or values thereof can be promoted, or as the one or more measurements do not satisfy particular rules of the heuristics, the quality score assigned to the one or more measurements or values thereof can be demoted. Once the heuristics have been performed on the one or more measurements, the one or more measurements can be left with the final quality score assigned which resulted from the promotions or demotions from the default quality score. In some instances, the one or more measurements or values thereof may not be demoted (or at least not as significantly) as a result of the heuristics if the values of the one or more measurements are considered or determined to be fixable because fixing may be performed to address lower quality rather than assigning a relatively lower quality to the one or more measurements.

Multiple different heuristics can be applied to different measurements for one or more different vehicles. The heuristics performed can be selected based at least on one or more of characteristics of a vehicle, a driver of the vehicle, or a manager of the vehicle, in some instances. One or more of the heuristics can involve comparing a value of a measurement to one or more other values of other measurements or one or more thresholds to assess whether the value of the measurement may be realistic or feasible. Examples of heuristics that can be performed to assign a quality score to the measurement can include one or more of the following or the like:
If a driving distance divided by a driving time for a vehicle exceeds a threshold (for example, 100 miles per hour), one or more measurements (or values thereof) related to or used to determine the driving distance or the driving time can be assigned a quality score indicative of low quality or receive a demotion in the assigned quality score.
If an idle time for a vehicle exceeds a threshold (for example, 20 hours), one or more measurements (or values thereof) related to or used to determine the idle time can be assigned a quality score indicative of low quality or receive a demotion in the assigned quality score.
If a distance between a start location and an end location for a vehicle differs by more than a threshold from an estimated distance drivable during a driving time at a driving speed for the vehicle, one or more measurements (or values thereof) related to or used to determine the distance, start location, end location, estimated distance drivable, driving time, or driving speed can be assigned a quality score indicative of low quality or receive a demotion in the assigned quality score.
If a fuel consumption divided by a driving distance for a vehicle exceeds an estimated maximum fuel usage for the vehicle, one or more measurements (or values thereof) related to or used to determine the fuel consumption and the driving distance can be assigned a quality score indicative of low quality or receive a demotion in the assigned quality score.
If a driving path for a vehicle determined from global positioning system (GPS) measurements suggests that a vehicle teleported or moved faster than a threshold between positions, one or more measurements (or values thereof) related to or used to determine the driving path can be assigned a quality score indicative of low quality or receive a demotion in the assigned quality score.

Moreover, heuristics can be applied to one or more measurements to assign a quality descriptor to the one or more measurements or values thereof. The quality descriptor can be selected from multiple quality descriptors and can provide an indication, such as a textual description (for instance, a plain English description), of one or more reasons why the one or more measurements or the values thereof were assigned a particular quality score. The quality descriptor can enhance the ability of an individual or the vehicle management system 110 to troubleshoot quality issues with the one or more measurements, the values thereof, a component of a vehicle, a telematics-generating component, or of the vehicle management system 110 itself, by providing potentially valuable information regarding what may have caused a quality decrease or increase. The assignment of the quality descriptor to the measurements or the values thereof can be performed periodically or randomly or triggered (for instance, when a change in values of measurements exceeds a threshold or when one or more other measurements receive a demotion in assigned quality score).

An indication of the quality score or the quality descriptor assigned to measurements or values of the measurements can be stored in a memory for later retrieval and reference. For example, the telematics service 132 or the data quality service 302 can store an indication of the quality score and the quality descriptor assigned to one or more measurements in a storage media of the vehicle management system 110, such as the quality data store 320, in association with values of the one or more measurements.

One or more quality scores or quality descriptors assigned to measurements or values of the measurements can additionally be used by the vehicle management system 110 to automatically change one or more operations of the vehicle management system 110 or to automatically cause one or more of the operations of a component of a vehicle, a telematics-generating component, or an in-vehicle device 104 associated with the measurements and values thereof to be changed (for instance, by sending a command message that alters a behavior of the component or the telematics-generating component). The one or more changed operations can potentially address or remediate a quality issue and result in an improved quality of the measurements and values thereof in the future. For example, the one or more changed operations can include: (i) adjusting one or more settings (for instance, modes of operation, data gathering approaches, sensor sensitivities, or the like) of the vehicle management system 110, the component of the vehicle, or the telematics-generating component, (ii) installing updated operating or calibration software on the vehicle management system 110, the component of the vehicle, or the telematics-generating component, (iii) resetting the component of the vehicle or the telematics-generating component, (iv) cycling power of the component of the vehicle or the telematics-generating component, (v) displaying a message (for instance, recommendations like the quality descriptor for addressing the quality issue or to bring a vehicle in for maintenance service) on a screen of an in-vehicle device 104 associated with the measurements and values thereof, (vi) disabling the component of the vehicle or the telematics-generating component, (vii) triggering a troubleshooting software to evaluate the component of the vehicle or the telematics-generating component, (viii) adjusting a routing schedule for a vehicle associated with the measurements and values thereof (for instance, adjusting a route determined by the routing service 112 to add a maintenance service stop in place of one or more previously assigned delivery stops and reassign the one or more previously assigned delivery stops to another vehicle), (ix) ordering a new part for the vehicle management system 110, the component of the vehicle, or the telematics-generating component to attempt to address the quality issue, or (x) scheduling a maintenance appointment for a vehicle or driver associated with the measurements and values thereof.

The quality scores assigned to measurements for vehicles can be trended over time on a plot and displayed to a manager of the vehicles. In one example, a set of the measurements can be assigned (i) during an initial time period the quality score of 3 indicating a high quality, (ii) during a later time period the quality score of 2 indicating a moderate quality, (iii) during a further later time period the quality score of 1 indicating a low quality, and (vi) during a final time period the quality score of 3 indicating a high quality. This numbering scale is merely illustrative and other approaches may be used. The manager can provide a user input to the vehicle management system 110, such as via one of the management devices 106, indicating a request for display of quality of the set of the measurements or values thereof to be trended on a plot. In some embodiments, a low quality score can be associated with untrustworthy measurements or values thereof, a moderate quality score can be associated with suspect measurements or values thereof, a favorable quality score can be associated with good measurements and values thereof, and a high quality score can be associated with trustworthy measurements and values thereof.

The plot used to trend quality scores can advantageously, in certain embodiments, enable the manager to visually understand changes in the quality score assigned to measurements or values thereof over time. The manager, in the example of the preceding paragraph, can easily understand that the quality of the measurements or the values thereof was high during the initial time period and gradually decreased during the later time period and the further later time period. At the final time period, the quality of the measurements or the values thereof can be observed to again increase to the quality of the measurements during the initial time period. Such trending can advantageously, in certain embodiments, enable the manager or another individual working in the computing environment 100 to troubleshoot sources of measurements, detect bad measurements or values thereof, or show the health of measurements or values thereof.

Measurements or values thereof having a certain quality score can be displayed or trended separately from measurements or values thereof having a different quality score. In one example, one or more measurements or values thereof having a quality score indicating low quality can be hidden from display, excluded from data analysis or processing, or discarded from the vehicle management system 110. In another example, one or more measurements or values thereof having certain quality scores can be trended to illustrate a health of data collected by the vehicle management system 110. This can additionally facilitate the troubleshooting of sources of data.

### II. Vehicle Management System

FIG. 1 illustrates an embodiment of a computing environment 100 for processing standardized vehicle operation information using a vehicle management system 110. Among other features, the example vehicle management system 110 shown includes a telematics service 132 that can receive and analyze vehicle data to provide vehicle operation information and configure the collection of measurement data related to the operation of fleet vehicles.

In the computing environment 100, one or more in-vehicle devices 104 and management devices 106 communicate with the vehicle management system 110 over a network 108. The in-vehicle devices 104 can include computing devices installed in fleet vehicles. These devices 104 can include navigation functionality, routing functionality, and the like. The in-vehicle devices 104 can receive route information and other information from the vehicle management system 110. In addition, the in-vehicle devices 104 can report information to the vehicle management system 110, such as driver location, vehicle sensor data, vehicle status (e.g., maintenance, tire pressure, or the like), and so forth.

The illustrated network 108 may be a LAN, a WAN, the Internet, combinations of the same, or the like. For ease of illustration, the vehicle management system 110 has been depicted as a centralized system or platform. However, in other implementations, at least some of the functionality of the vehicle management system 110 is implemented in other devices or in multiple servers or data centers. For example, the vehicle management system 110 can be implemented as software as a service (SaaS) in the cloud and may be located in multiple data centers around the world (or portion thereof). Other possible implementations of the vehicle management system 110 can include many more or fewer components than those shown in FIG. 1.

The management devices 106 can be computing and input/output (I/O) devices used by dispatchers, fleet managers, administrators, or other users to manage different aspects of the vehicle management system 110. For example, a user of a management device 106 can access the vehicle management system 110 to generate routes, dispatch vehicles and drivers, and perform other individual vehicle or fleet management functions. With the management devices 106, users can access and monitor vehicle information obtained from one or more of the in-vehicle devices 104 by the vehicle management system 110. Such vehicle status information can include data on vehicle routes used, stops, speed, vehicle feature usage (such as power takeoff device usage), driver behavior and performance, vehicle emissions, vehicle maintenance, energy usage, and the like. In some embodiments, the management devices 106 are in fixed locations, such as at a dispatch center. The management devices 106 can also be used by administrators in the field, and may include mobile devices, laptops, tablets, smartphones, personal digital assistants (PDAs), desktops, or the like. The management devices 106 can include a display 107 that can be used to display data quality as described herein.

The vehicle management system 110 can be implemented by one or more physical computing devices, such as servers. These servers can be physically co-located or can be geographically separate, for example, in different data centers. In one embodiment, the vehicle management system 110 is implemented as a cloud computing application. For instance, the vehicle management system 110 can be a cloud-implemented platform hosted in one or more virtual servers and/or physical servers accessible to users over the Internet or other network 108. In the depicted embodiment, the vehicle management system 110 includes a fleet management service 126, a mapping service 114, a telematics service 132, a routing service 112, a dispatch service 124, and an integration service 122. These components can, but need not, be integrated together on a common software or hardware platform.

The fleet management service 126 can include functionality for generating, rendering, or otherwise displaying one or more vehicle management user interfaces. The vehicle management user interfaces can include a map or list of vehicles that depicts symbols or other data representative of vehicles. In addition, the vehicle management user interfaces can optionally include a history timeline display. For example, in response to user selection of one or more of the vehicle symbols from the map or list, the vehicle management user interface can output one or more vehicle history timelines corresponding to the selected vehicle or vehicles. Although the fleet management service 126 generates the user interface, in certain embodiments the fleet management service 126 outputs the user interface to the management devices 106, which actually display the user interface and associated history timeline display. Thus, as used herein, the terms “output a user interface for presentation to a user,” “presenting a user interface to a user,” and the like, in addition to having their ordinary meaning, can also mean (among other things) transmitting user interface information over a network, such that a user device can actually display the user interface.

The fleet management service 126 can communicate with the mapping service 114 to obtain mapping data, which the fleet management service 126 can include in the vehicle management user interface. The mapping data can be compressed, transmitted, re-rendered, and displayed on the management user interface. Other data can also be overlaid to enhance the map and management layout. The mapping service 114 can be a geographic information system (GIS) in one embodiment. The fleet management service 126 can also access the telematics service 132 to obtain vehicle status data for inclusion in vehicle history displays. The telematics service 132 can provide this vehicle status data based on telematics data obtained from the in-vehicle devices 104. The telematics data can include data such as location or speed information obtained using sequential GPS or cellular tower triangulation (or other methods), vehicle sensor data, solid state inertial information, or any other data that can be obtained from a vehicle, its engine, or the like (including other sensors such as passenger seat sensors to detect the presence of passengers and so forth).

The routing service 112 can construct pre-dispatch or post-dispatch routes for vehicles based on any of a variety of routing algorithms, such as those disclosed in U.S. Publication No. 2010/0153005, filed Dec. 8, 2009, and entitled “System and Method for Efficient Routing on a Network in the Presence of Multiple-Edge Restrictions and Other Constraints,” the disclosure of which is hereby incorporated by reference in its entirety. In addition, the routing service 112 can automatically select routes that take into account factors that affect energy usage using the techniques described in U.S. application Ser. No. 12/954,547, filed Nov. 24, 2010, and entitled “Vehicle Route Selection Based on Energy Usage,” the disclosure of which is hereby incorporated by reference in its entirety.

The integration service 122 can facilitate integration of the vehicle management system 110 with other systems, such as fuel card systems, payroll systems, supply chain system, insurance systems, and the like. The dispatch service 124 can provide functionality for users of the management devices 106 to assign drivers and vehicles to routes selected by the routing service 110.

In the depicted embodiment, the vehicle management system 110 includes a telematics service 132, which can be implemented in hardware and/or software.

### III. Telematics Service

The telematics service 132 can obtain and receive measurement data related to vehicles and fleets of vehicles via telematics data received from the in-vehicle devices 104. The telematics data can include data such as location or speed information obtained using GPS or cellular tower triangulation (or other methods), vehicle sensor or diagnostic data, solid-state inertial information, or any other data that can be obtained from a vehicle, its engine, or the like (including other sensors such as passenger seat sensors to detect the presence of passengers and so forth). Examples of specific measurements that can be obtained for some fleet vehicles include A/C System Refrigerant Monitor, Alternator Voltage, Brake Indicator Light, Coasting Time, Engine Oil Level, Fuel Level, Hydraulics On, Odometer, Rear Door, Tire 3 Pressure, Total Fuel Used, and Turn Signal Status. Other examples of specific measurements are described below with respect to FIG. 2. In some implementations, telematics data can be additionally or alternatively received from one or more other sources, for example, such as directly from other components of the vehicle, via manual data entry to a user interface (e.g., by the driver), or a server configured to receive and store fleet vehicle operation measurements.

Because a vehicle fleet may include vehicles having different makes, models, and or model years having different operation reporting capabilities (e.g., providing direct measurements or one or more indirect measurements of vehicle operations information), the data available to the telematics service 132 can be different for some vehicles of the vehicle fleet than for other vehicles. In one example, if a vehicle fleet includes both light-duty vehicles, such as commuter vehicles, and heavy-duty vehicles, such as semi-trailers, the light-duty and heavy-duty vehicles can report different operation measurements usable for understanding the operation of the vehicles. The heavy-duty vehicles and one group of the light-duty vehicles can, for instance, maintain an odometer measurement readable by the in-vehicle devices 104. The odometer measurement can be provided by the in-vehicle devices 104 to the telematics service 132. On the other hand, another group of light-duty vehicles in the vehicle fleet may not be capable of outputting odometer measurements readable by the in-vehicle devices 104. Instead, the drivers of the vehicle may be expected to manually read the odometer measurements and provide the measurements with corresponding timestamps for input to the telematics service 132.

Because the accuracy or precision of measurements can vary significantly depending on the source, timing, sophistication, or the like for the measurements, the measurements obtained by the telematics service 132 can be associated with one or more indications of the quality of the measurements. The telematics service 132 can assign a value from multiple values that corresponds to the level of quality for one or more measurements. This assignment can be based on the source of information, age of information, precision of information, estimated accuracy of information, or the like. Additionally or alternatively, the telematics service 132 can receive the measurements and one or more indications of the quality of the measurements from the in-vehicle devices 104. Moreover, in some embodiments, the one or more indications of the quality of the measurements can be utilized by the telematics service 132 to manage or process the measurements. For instance, the telematics service 132 can request or discard certain measurements related to particular vehicles in the vehicle fleet based on the one or more indications of the quality.

### IV. In-Vehicle Devices

FIG. 2 illustrates an embodiment of a gateway device 205. The gateway device 205 is a more detailed embodiment of an in-vehicle device 104 described above and includes all the features thereof. The gateway device 205 can be a vehicle based data acquisition and transmission sub-system. In the depicted embodiment, the gateway device 205 has a processor 210, memory 215, a wireless adapter 220, and one or more sensors 225. In some embodiments, the sensors 225 are omitted. The sensors 225 can be configured to measure vehicle data, such as vehicle position, temperature, time, acceleration, audio, and direction.

A radio 240 communicates with the gateway device 205, either wirelessly or through a wired connection (e.g., with a serial cable or the like). The radio 240 includes a GPS service 245 that detects vehicle position. The radio 240 can transmit data received from the gateway device 205 to the vehicle management system 110. The radio 240 can also communicate vehicle positioning data received from the GPS service 245 to the vehicle management system 110. In one embodiment, the radio 240 communicates with the vehicle management system by placing a cell phone call to a server of the vehicle management system 110. The radio 240 can also communicate with the server at the vehicle management system 110 by connecting to the network 108 using TCP/IP/UDP protocols. By sending data frequently or periodically, the radio 240 can maintain the connection to the server open, which can guarantee or help to guarantee data reliability.

Any number of in-vehicle sensors 230 located within the vehicle can communicate with the gateway device 205. The in-vehicle sensors 230 can be located throughout the vehicle, including, for example, the engine, tires, vehicle body, trailer, cargo areas, and other locations on and within the vehicle. Some examples of vehicle sensors include engine oil sensors, fuel level sensors, light sensors, door sensors, ignition sensors, temperature sensors (including in cab and in trailer), and tire pressure sensors. At least some of the in-vehicle sensors 230 can communicate with the engine computer or other engine hardware configured to receive and process the data. The in-vehicle sensors can also be located remotely and can transmit the data wirelessly to the engine computer or other data processing hardware. For example, a tire pressure sensor could wirelessly transmit tire pressure data to the engine computer for processing.

Likewise, the gateway device 205 can also include sensors. One example of a sensor 225 that may be included in the gateway is an accelerometer. An accelerometer can detect hard braking, cornering, and acceleration. The accelerometer can therefore allow position coordinates to be updated without resort to GPS or triangulation technology. For example, the accelerometer can provide for short-term position reporting that operates without resorting to GPS signals. The gateway device 205 can offer a low cost longitude, latitude capability and combined hard braking sensor for vehicle history applications, such as the vehicle history systems and methods described in U.S. application Ser. No. 13/251,129, titled “History Timeline Display for Vehicle Fleet Management,” filed Sep. 30, 2011, the disclosure of which is hereby incorporated by reference in its entirety. As a device, in certain embodiments, the gateway device 205 can enable data from multiple sensors to be acquired without adding wires or optical connections.

The gateway device 205 can be in communication with some or all of the in-vehicle sensors 230. For example, the gateway device 205 can be coupled to an OBDII or CAN bus in the vehicle to thereby receive in-vehicle sensor information from the engine computer. In some embodiments, one or more in-vehicle sensors can be directly coupled to the gateway device 205, or the gateway device 205 can be configured to communicate wirelessly with the in-vehicle sensors. For example, the gateway device could receive cargo bay temperature data from a temperature sensor wirelessly transmitting the data. The wireless sensors can use point-to-point custom wireless transmission or using wireless transmission standards such as Bluetooth or Zigbee.

The processor 210 and memory 215 of the gateway device 205 can implement various features. The processor 210 of the gateway device 205 can control the functioning of the gateway device 205. The gateway device 205 can act as an intermediary processing platform for the vehicle management system 110. The gateway device 205 can process the data received from the in-vehicle sensors 230 and send a subset of the total data collected to the vehicle management system 110. The gateway device 205 can collect hundreds or thousands or more data points from sensors 225, in-vehicle sensors 230, and the engine computer. The gateway device 205 can, among other things, analyze, categorize, compress, or otherwise process the data before transmitting it to the vehicle management system 110. By preprocessing the data prior to sending the information to the vehicle management system 110, the gateway device 205 can determine what data to send to the vehicle management system 110, which can reduce redundant processing and bandwidth used to continually transmit vehicle data.

In some embodiments, the measurements determined by the sensors 225, in-vehicle sensors 230, or the engine computer can, for example, include one or more of the following: A/C System Refrigerant Monitor, ABS Active Lamp, Abnormal Refrigerator Temperature, Acceleration Violations, Accelerator Pedal Position, Air Inlet Temperature, Airbag Light, Alternator Current, Alternator Voltage, Amber Warning Lamp (DM1), Ambient Air Temperature, Ammonium Nitrate Grand Total, Antitheft System Active, Asset Power, Auto Lube Alarm, Average Fuel Economy, Backup Battery Voltage, Barometric Pressure, Battery Charge, Battery Voltage, Belly Dump, Boom Status, Brake Indicator Light, Brake Pedal Switch, Cab Interior Temperature, Cargo Air Temperature, Catalyst Monitor, Check Fuel Cap, Coasting, Coasting Time, Comprehensive Component Monitor, Coolant Hot Light, Coolant Level, Coolant Pressure, Cruise Control Set Speed, Cruise Control Status, Deceleration Violations, Defroster, Diagnostics Scan Tool Connected, Diesel Particulate Filter Status, Diesel Pump, Driver Door, Dump Arm, EGR System Monitor, Emulsion Grand Total, Emulsion Job Total, Engine Coolant Pressure, Engine Coolant Temperature, Engine Load, Engine Oil Level, Engine Oil Pressure, Engine Oil Temperature, Engine Speed, Engine Start Event, Engine Stop Event, Evaporative System Monitor, Failure Mode Identifier (DM1), Flash Amber Warning Lamp (DM1), Flash Malfunction Indicator Lamp (DM1), Flash Protect Lamp (DM1), Flash Red Stop Lamp (DM1), Fuel Level, Fuel Oil Grand Total, Fuel Oil Job Total, Fuel Rate, Fuel Remaining, Fuel System Monitor, Fuel Temperature, Gasoline Pump, Harsh Acceleration, Harsh Braking, Heated Catalyst Monitor, High Engine Temperature, High Wind Speed, Hopper #1-4, Hydraulic Fluid Temperature, Hydraulic Pressure, Hydraulics On, Idle Time, Ignition, In Cradle, J1939 DTC, Lift, Lights, Low Brake Fluid, Low Engine Oil Pressure, Low Fuel Level, Low Tire Pressure, Low Wind Speed, Malfunction Indicator Lamp Status (DM1), Max Acceleration, Max Deceleration, Misfire Monitor, Net Battery Current, OBDII DTC, Occurrence Count (DM1), Odometer, Oil Life Remaining, Oil Pressure Lamp, Oxygen Sensor Heater Monitor, Oxygen Sensor Monitor, PTO, Panic, Passenger Door, Pony Motor Running, Protect Lamp Status (DM1), RSSI, Raining, Rear Door, Red Stop Lamp Status (DM1), Refrigeration Temperature, Refrigeration Temperature 2, Reserved For Future Use, SPN Conversion Method (DM1), Seatbelt Fastened, Seatbelt Warning Light, Secondary Fuel Level, Service Trashcan, Side Door, Speeding Over Max, Suspect Parameter Number (DM1), Sweeper Engine, Tires 1-12 Pressure, Tires 1-12 Sensor ID, Tires 1-12 Temperature, Total Engine Time, Total Fuel Used, Total Idle Fuel Used, Total Idle Fuel Used, Total Idle Hours, Total PTO Time, Total Vehicle Time, Track Motor, Trailer Coupled, Transmission Fluid Temperature, Transmission Gear, Transmission Oil Level, Trip Distance, Trip Duration, Trip Fuel Used, Trip Fuel Used Idling, Trip Max Vehicle Speed, Trip Time At Full Throttle, Trip Time Driving Without Seatbelt, Trip Time In Optimal RPM Range, Trip Time Speeding, Trip Time With Cruise Control On, Trip Time With RPM High, Turn Signal Status, Vehicle Loaded, Vehicle Speed, Washer Fluid Level, Water In Fuel, Welder, iButton Driver Id Event.

The gateway device 205 can monitor several vehicle characteristics. The sensors 225, 230 can provide information to the gateway device 205 at a specific frequency for each vehicle characteristic; however, the sensors 225, 230 may generally be recording data at a faster rate than the monitored vehicle characteristic is changing. As such, sending all of the data to the vehicle management system 110 every time a sensor provides data can waste bandwidth and provide redundant data points for the vehicle management system 110 to process. Advantageously, in certain embodiments, instead of sending all of this data to the vehicle management system 110, the gateway device 205 processes the data and selectively updates the vehicle management system 110. The gateway device 205 can also compress the data that is received. The gateway device 205 can selectively compress portions of the data using wavelet transforms or other compression techniques, including any lossy or lossless compression techniques. For example, the data relating to vehicle characteristics that are slowly changing can be compressed.

The gateway device 205 can process vehicle characteristics according to the rate at which the characteristics change. For example, engine characteristics can range from relatively slower changing characteristics, such as tire pressure or average fuel consumption, to relatively faster changing characteristics, such as engine RPM and speed. The gateway device 205 can provide updates to the vehicle management system 110 using different update approaches for each vehicle characteristic, including periodic updates, threshold-based updates, event-based updates, user-specified updates, and/or a combination of methods.

Periodic updates can provide updates to the vehicle management system at a specified frequency. For example, the gateway device 205 may update the remaining vehicle fuel data every 5 minutes. Threshold based updates can provide updates when the value of the vehicle characteristic meets or exceeds a specified threshold. The thresholds can be static, determined dynamically by the system, user specified, or determined using any other method. The thresholds can be absolute, such as a specific value, or relative, such as a percentage based change a specific number of units. For example, tire pressure data could be updated when the tire pressure changes by 10%, or when it changes by 2 psi, or if pressure drops below 35 psi. Event-based updates can prompt updates after a specific event occurs. For example, an update of all the vehicle characteristics may be provided when the engine starts or when an engine error is detected.

The gateway device 205 can use a combination of methods or algorithms to determine the frequency of the updates to the vehicle management system 110. For example, the tire pressure data could have a periodic update and a threshold based update. The tire pressure data could be updated every 30 minutes. However if there was a blowout, it can be beneficial to have a more rapid or immediate update to the tire pressure. As such, the gateway device 205 could evaluate the tire pressure against a threshold that updates tire pressure when a change is detected. The gateway device 205 can provide update routines that are dependent on the operational phase of the vehicle, such as warm-up operation versus normal operation. As engine conditions stabilize after warm-up the gateway device 205 can increase the intervals at which updates are provided to the vehicle management system 110. In some embodiments the gateway device 205 can send the updated data to the vehicle management system 205 and the raw data. The raw vehicle data can include some or all of the data that the gateway device 205 receives from the sensors and vehicle computer. The raw data can be transmitted with or without the preprocessed updated vehicle data.

More generally, in certain embodiments, the gateway device 205 can be a system that performs wired or wireless data acquisition within a vehicle. The gateway device 205 can pool data from various sensors, apply time stamps to the data, reformat the data, encode the data, or encrypt the data. Software running on the gateway device 205 can manage data acquisition and data formatting. The gateway device 205 can therefore acquire diagnostic bus and motor vehicle status data and buffer the data and forward the data directly to the vehicle management system or another in-vehicle device (such as a driver's cell phone, tablet, or laptop) via WiFi, Ethernet, RS232/422, USB, or other suitable physical interfaces.

### V. Data Quality Service

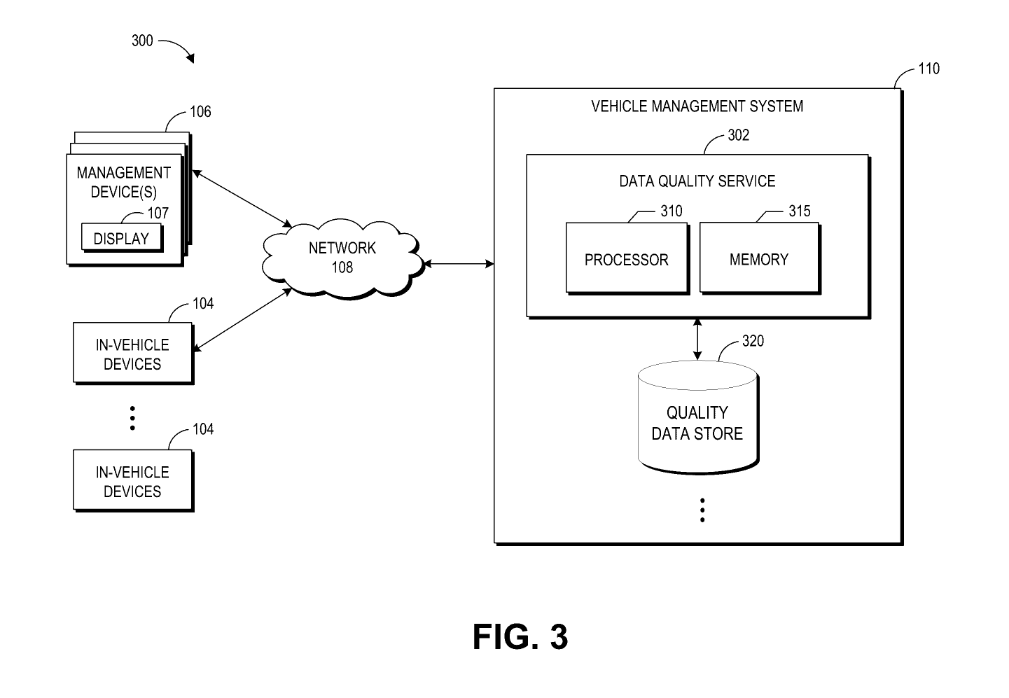

FIG. 3 illustrates an embodiment of a data quality service 302 in the context of a computing environment 300. The computing environment 300 may be similar to the computing environment 100 of FIG. 1. For example, the in-vehicle devices 104, the vehicle management system 110, and other components of FIG. 3 may be similar to the devices, systems, and other components of FIG. 1. In particular, while not illustrated, the vehicle management system 110 of FIG. 3 may include the services described with respect to the vehicle management system 110 of FIG. 1. Further, the embodiment vehicle management system 110 of FIG. 3 includes the data quality service 302 and the data quality store 320, as described herein, which may communicate with other services and devices of the vehicle management system 110. In some embodiments, the data quality service 302 is the same as or may have functionality that is similar to the telematics service 132.

In the depicted embodiment, the data quality service 302 has a processor 310 (also referred to herein as a hardware processor) and a memory 315. The processor 310 and memory 315 of the data quality service 302 can implement various features. The processor 310 can control the functioning of the data quality service 302. The data quality service 302 can act as a processing platform for the vehicle management system 110. The data quality service 302 can process the data received from the in-vehicle sensors 230 and determine one or more data quality scores for the received data. The data quality service 302 can process hundreds or thousands or more data points from the in-vehicle sensors 230. The data quality service 302 can, among other things, analyze, categorize, or otherwise process the data for use by the vehicle management system 110, as described herein. The processed data, such as the one or more data quality scores, may be stored in the quality data store 320.

The quality data store 320 may be embodied in hard disk drives, solid state memories, any other type of non-transitory computer-readable storage medium, and/or a file, a database, an object orientated database, document store, a relational database, in-memory cache, and/or stored in any such non-transitory computer-readable media accessible to the data quality service 302. The quality data store 320 may also be distributed or partitioned across multiple local and/or remote storage devices without departing from the spirit and scope of the present disclosure.

### VI. Quality Assignment and Display Process

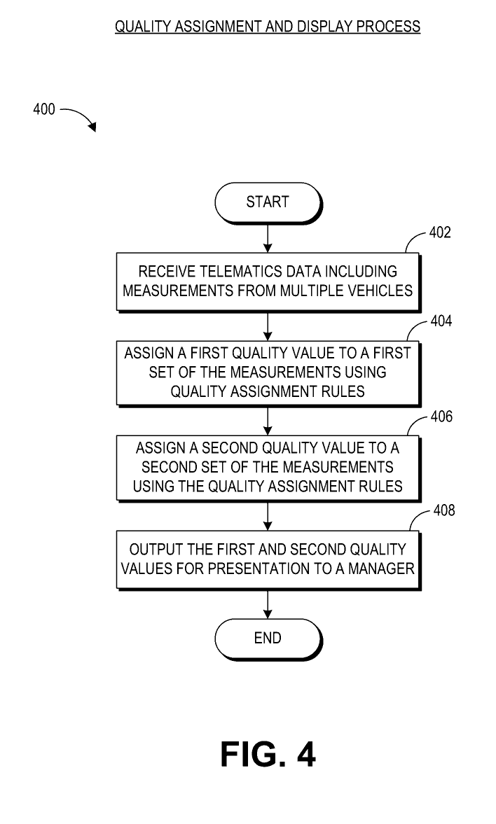

FIG. 4 depicts an embodiment of a quality assignment and display process 400. The process 400 illustrates an example mode of operation of the computing environment 100 of FIG. 1 or 3 and may be implemented by the various components shown in the computing environment 100. For convenience, the process 400 is described in the context of the computing environment 100 but may instead be implemented by other systems described herein or other computing systems not shown. The process 400 provides one example approach by which the vehicle management system 110 can assign quality values to measurements associated with operation of a fleet of vehicles and output the quality values for presentation on a display to a manager (for instance, a dispatcher, scheduler, or maintenance worker) of the fleet of vehicles. Advantageously, in certain embodiments, the process 400 can facilitate the presentation of quality information to the manager enabling the manager to (i) better understand the quality of the measurements or values thereof and (ii) make better decisions in view of the better understanding of the quality of the measurements or values thereof.

At block 402, the telematics service 132 can receive vehicle telematics data for multiple vehicles in a fleet of vehicles. The vehicle telematics data can include measurements related to operation of the multiple vehicles. At block 404, the telematics service 132 can assign a first quality value to a first set of the measurements according to quality assignment rules, such as using the approaches described herein. At block 406, the telematics service 132 can assign a second quality value different from the first quality value to a second set of the measurements according to the quality assignment rules, such as using the approaches described herein. The second quality value can be associated with lower quality than the first quality value, and the first set can provide information about a vehicle of the multiple vehicles during a first time period and the second set can provide the information about the vehicle during a second time period different from the first time period. At block 408, the telematics service 132 can output the first quality value and the second quality value for presentation on a display, such as a display of a management device 106, to a manager of the fleet of vehicles so that (i) the first quality value is displayed in association with the first time period and (ii) the second quality value is displayed in association with the second time period.

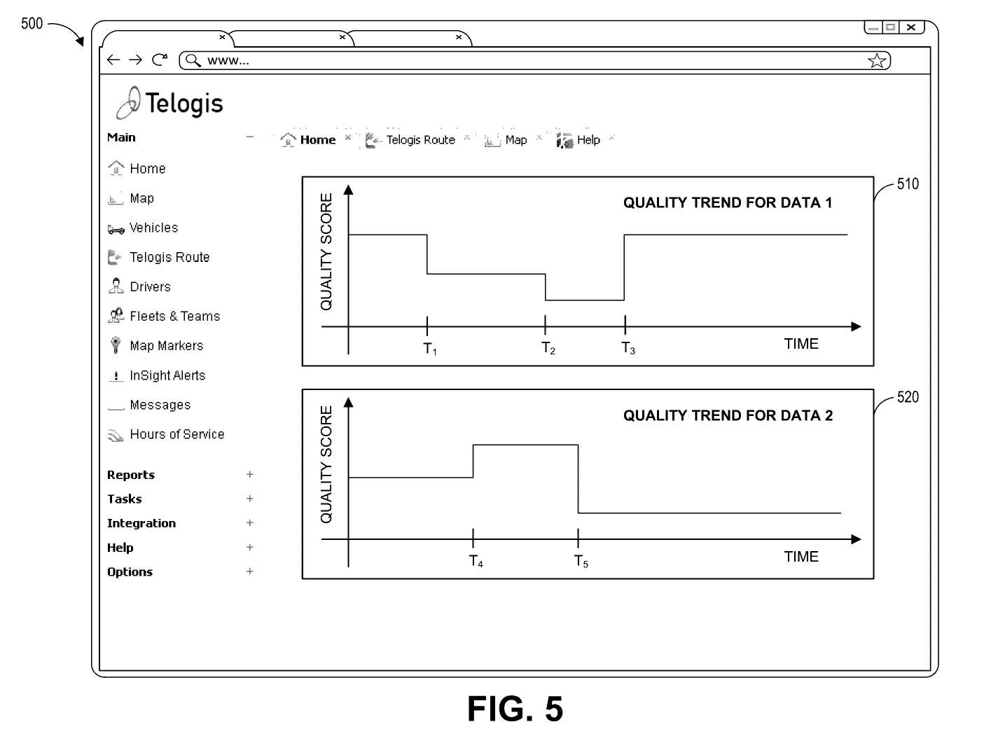

FIG. 5 illustrates an example of a user interface 500 for presenting data quality information to a user. The user interface 500 can, for instance, be displayed by the fleet management service 126 via one of the management devices 106. The user interface 500 can advantageously, in certain embodiments, enable the quality of data to be shown to the user as a trend over time, such as via plots, so that the user can understand variations in quality of the data over time. The data displayed by the user interface 500 can, for example, be measurements, values of the measurements, other parameters described herein, or the like.

The user interface 500 can display a first plot 510 and a second plot 520. The first plot 510 can depict a quality trend for Data 1 that includes displaying the quality score for Data 1 versus time over a time period. The second plot 520 can depict a quality trend for Data 2 that includes displaying the quality score for Data 2 versus time over a time period. The time periods displayed by the first plot 510 and the second plot 520 may be the same or different from one another.

As can be seen from the first plot 510, the quality of Data 1 can vary over the depicted time period. The quality score for Data 1 can initially be at a high quality score level. At time T₁, however, the quality of Data 1 can reduce from the high quality score level to a moderate quality score level. A time later, at time T₂, the quality of Data 1 can again reduce and now move to a low quality score level. Finally, at time T₃, the quality of Data 1 can increase back to the high quality score level. In one example, the first plot 510 can illustrate that the measurements or values thereof from a particular sensor for a vehicle. The measurements or values thereof may have initially been assigned high quality scores. However, at time T₁, the quality of the measurements or values thereof from the particular sensor may be begun to diminish, such as due to a sensor misconfiguration or needed repairs, so the measurements or values thereof may then have been assigned a moderate quality score. The quality of the measurements or values thereof can be then further seen to diminish as the sensor misconfiguration may not have been addressed or needed repairs may not have been performed, so the measurements or values thereof can be assigned a low quality score. At time T₃, the sensor misconfiguration may have now been addressed or the needed repairs may have been performed, so the quality of the measurements or values thereof from the particular sensor can again be assigned high quality scores.

As can be seen from the second plot 520, the quality of Data 2 can vary over the depicted time period. The quality score for Data 2 can initially be at a moderate quality score level. At time T₄, however, the quality of Data 2 can increase from the moderate quality score level to a high quality score level. A time later, at time T₅, the quality can dramatically reduce and move to a low quality score level. In one example, the second plot 520 can illustrate that the measurements or values thereof from a particular sensor of a vehicle. The measurements or values thereof may have initially been assigned moderate quality scores. However, at time T₄, the quality of the measurements or values thereof from the particular sensor may be begun to increase, such as due to a reconfiguration or replacement of a particular sensor for a vehicle at time T₄, so the measurements or values thereof may have been assigned a high quality score after time T₄. At time T₅, the particular sensor, however, may have become damaged or malfunctioned, so the measurements or values thereof may then have been assigned a low quality score.

The first plot 510 and the second plot 520 can be used as described herein, among other ways. For example, the first plot 510 and the second plot 520 can be used to troubleshoot the health of data or troubleshoot issues with the collection of data about vehicles, such issues with sensors associated with vehicles.

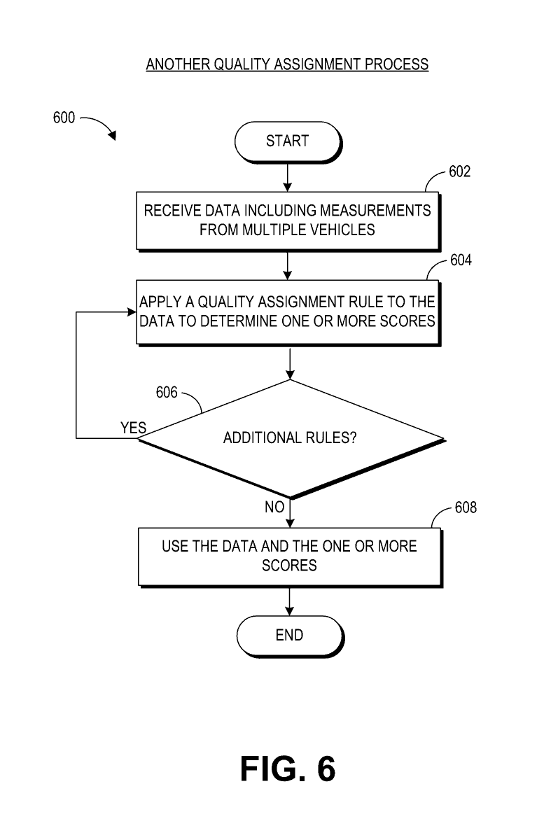

FIG. 6 depicts another embodiment of a quality assignment process 600. The process 600 illustrates an example mode of operation of the computing environment 100 of FIG. 1 or 3 and may be implemented by the various components shown in the computing environment 100. For convenience, the process 600 is described in the context of the computing environment 100 but may instead be implemented by other systems described herein or other computing systems not shown. In particular, the process 600 may be implemented by the data quality service 302 or the telematics service 132. The process 600 provides one example approach by which the vehicle management system 110 can assign quality scores to vehicle-related data associated with operation of a fleet of vehicles for use by the vehicle management system 110. For example, the determined data quality scores or levels may be presented in a user interface to a manager (for instance, a dispatcher, scheduler, or maintenance worker) of the fleet of vehicles. Advantageously, in certain embodiments, the process 600 can facilitate the presentation of quality information to the manager enabling the manager to (i) better understand the quality of the measurements or values thereof and (ii) make better decisions in view of the better understanding of the quality of the measurements or values thereof. For example, the vehicle-related data may be presented or filtered to users based on the one or more data quality scores. In some embodiments, one or more blocks of the example process 600 are similar to one or more blocks of the example process 400, which is described in further detail with respect to FIG. 4.

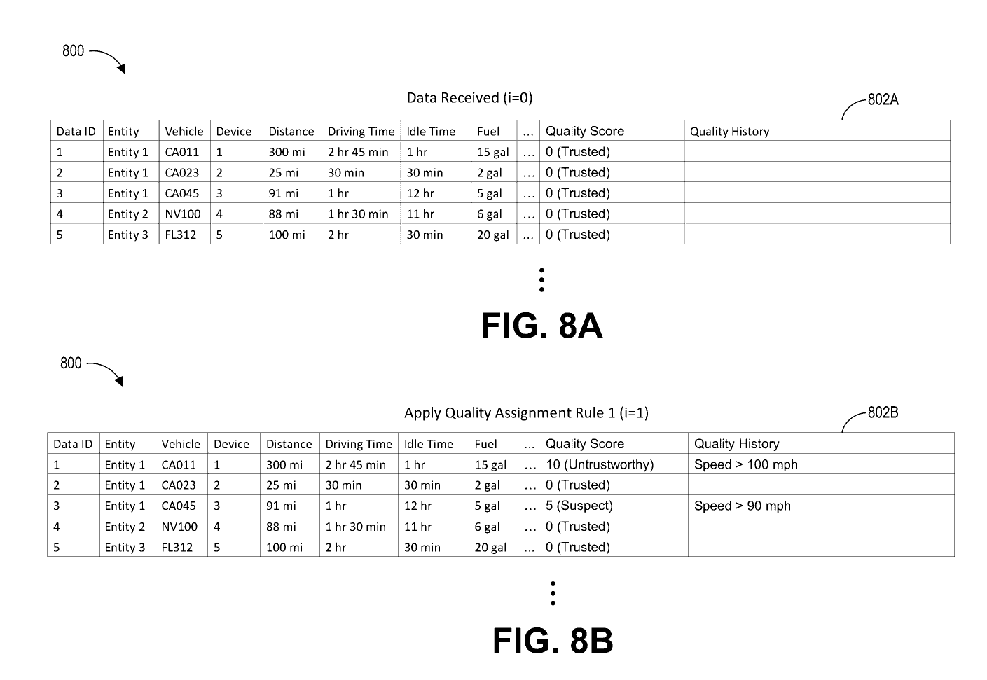

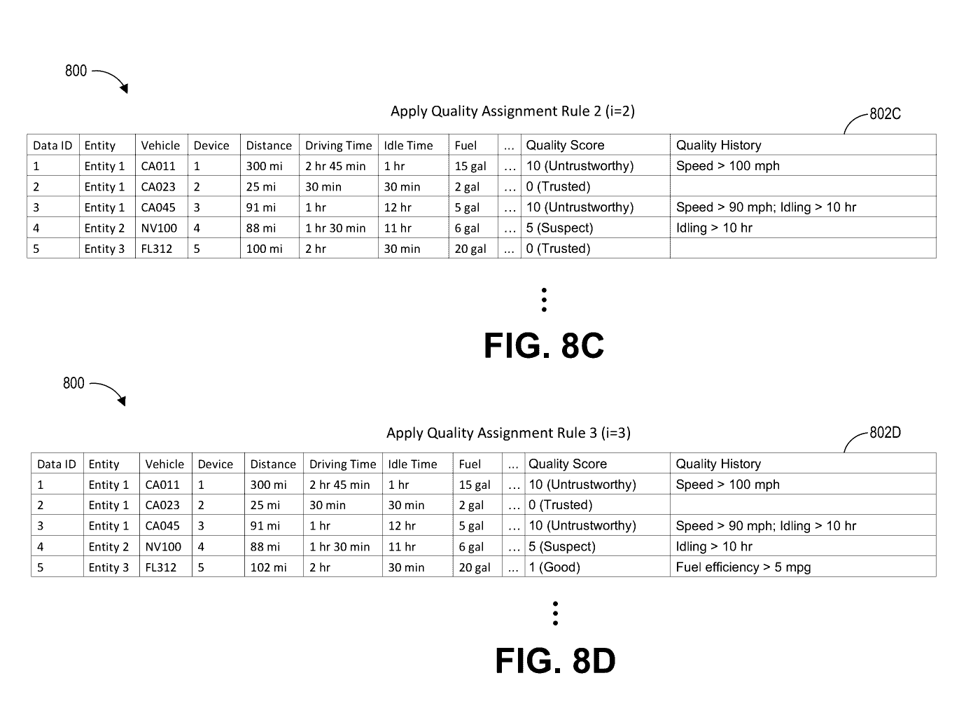

At block 602, the data quality service 302 receives vehicle-related data for one or more vehicles. The vehicle-related data can include measurements related to operation of the multiple vehicles, such as vehicle telematics data. As described herein, the vehicle-related data can be grouped, such as first data, second data, third data, etc. In some embodiments, each of the first data, second data, third data, etc. corresponds to a respective first vehicle, second vehicle, third vehicle, etc. Example first data may correspond to an entry in a data set or a row in a table, which is described in further detail with respect to FIGS. 8A-8D. In some embodiments, the data quality service 302 receives the vehicle-related data from one or more vehicles as part of an extract, transform, and load (“ETL”) process of the data. For example, the one or more in-vehicle devices 104, such as the gateway device 205, transmit vehicle-related data to the vehicle management system 110, and hence the data quality service 302, which performs the ETL process.

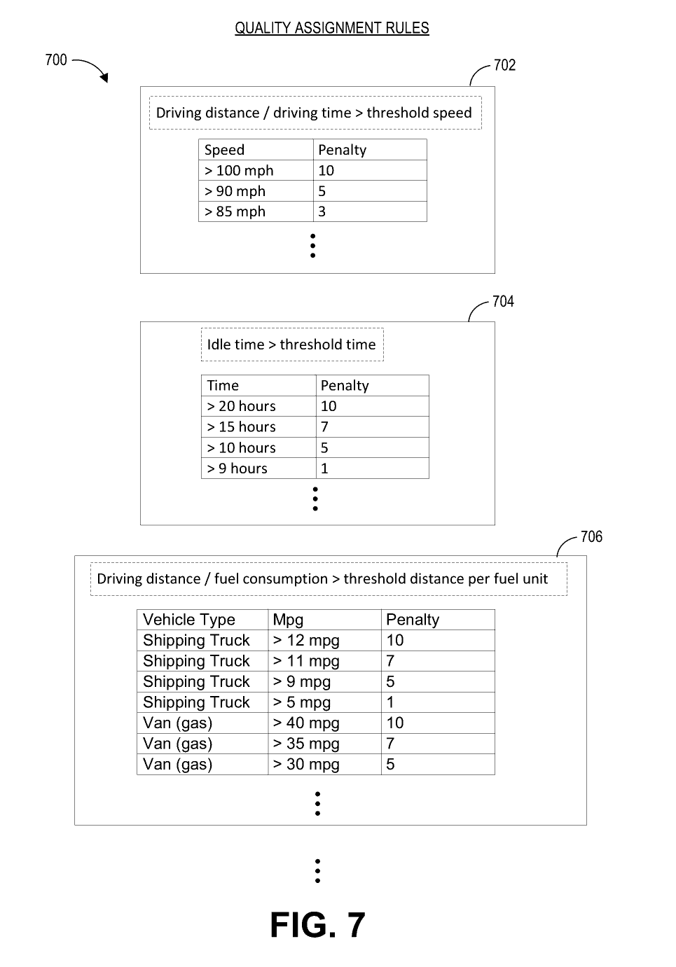

At block 604, the data quality service 302 applies a quality assignment rule to the data to determine one or more scores. As described herein, a quality assignment rule includes instructions that determine one or more quality scores for the data. An example quality assignment rule is a threshold speed rule, such as the quality assignment rule 702, which is described in further detail with respect to FIG. 7. In the example, the data quality service 302 applies the threshold speed rule to determine a data quality score for the corresponding data. The example quality assignment rule determines a speed, such as 100 miles per hour (“mph”), by dividing a distance, such as 300 miles, by a driving time, such as three hours. If the determined speed exceeds a threshold, then the example quality assignment rule determines a score, such as a penalty of 10 points. If the data value does not exceed one or more thresholds, then the data quality service 302 may not assign a corresponding score. As described herein, such as with respect to FIGS. 8A-8D, the data quality service 302 applies a quality assignment rule to multiple data entries or data rows of the received data.

In some embodiments, the data quality service 302 determines a value that is compared to one or more thresholds from a calculation according to a quality assignment rule. In the threshold speed rule, data is extracted or retrieved from a data entry, such as a distance and a driving time, which is used by the data quality service 302 to perform a speed calculation and determine a speed value to compare to one or more thresholds according to the speed quality assignment rule. Additional example calculations are described in further detail with respect to FIGS. 7 and 8A-8D. Accordingly, the application of the quality assignment rule may include a determination, from the data, of at least one of: a speed, a time, a distance, a mass, a weight, an electric current, a temperature, or a luminous intensity. For example, the quality assignment rule may include a determination, from the data, of at least one of: a driving speed, a driving time, an idle time, an amount of fuel, or a GPS coordinate.

In some embodiments, the data quality service 302 applies one or more quality assignment rules based on additional data or inputs. For example, some quality assignment rules are conditional based on a vehicle or one or more different thresholds. As described herein, the data quality service 302 may assign a different penalty score based on the degree of a data quality violation. For example, first data corresponding to a speed in excess of 80 mph may receive a first score, second data corresponding to a speed in excess of 90 mph may receive a second score, etc. Moreover, the thresholds or other logic of a quality assignment rule may be based on other data such as the vehicle type. Continuing with the example, the one or more thresholds for a speed violation for a commuter type vehicle may be different than one or more thresholds for a speed violation for a trucker type vehicle. Thus, the output of a quality assignment rule may be based on a vehicle type or other data.

At block 606, the data quality service 302 determines whether there are additional rules to apply to the received data. For example, the data quality service 302 may access second, third, fourth quality assignment rules, and so forth. Second and third example quality assignment rules are a threshold idle rule and a threshold distance per fuel unit rule, such as the quality assignment rules 704 and 706, which are described in further detail with respect to FIG. 7. The quality assignment rules may be applied by the data quality service 302 in an iterative manner to the received data by returning to block 604 until there are no additional rules or based on some other logic. Additional details regarding the iterative application of two or more quality assignment rules are described with respect to FIGS. 7 and 8A-8D. For example, the data quality service 302 may apply multiple rules to the same data entry or data row to determine a cumulative score or updated score based on the data corresponding to the data entry or data row. For example, a first rule determines a first score of 1 point for a data entry, a second rule determines a second score of 3 points for the same data entry, a third rule determines a third score of 5 points for the same data entry, and the data quality service 302 assigns a total score of 8 points to the data entry. Thus, the data quality service 302 may add a first score and another score to determine an updated score for the entry. The determination of cumulative data quality scores is described in further detail with respect to FIGS. 8A-8D. For example, each data entry may be initialized with an initial score and as respective data entries satisfy the one or more quality assignment rules the initial scores are updated accordingly. If there are no more additional rules or based on some other trigger logic, the data quality service 302 proceeds to block 608 to use the generated data.

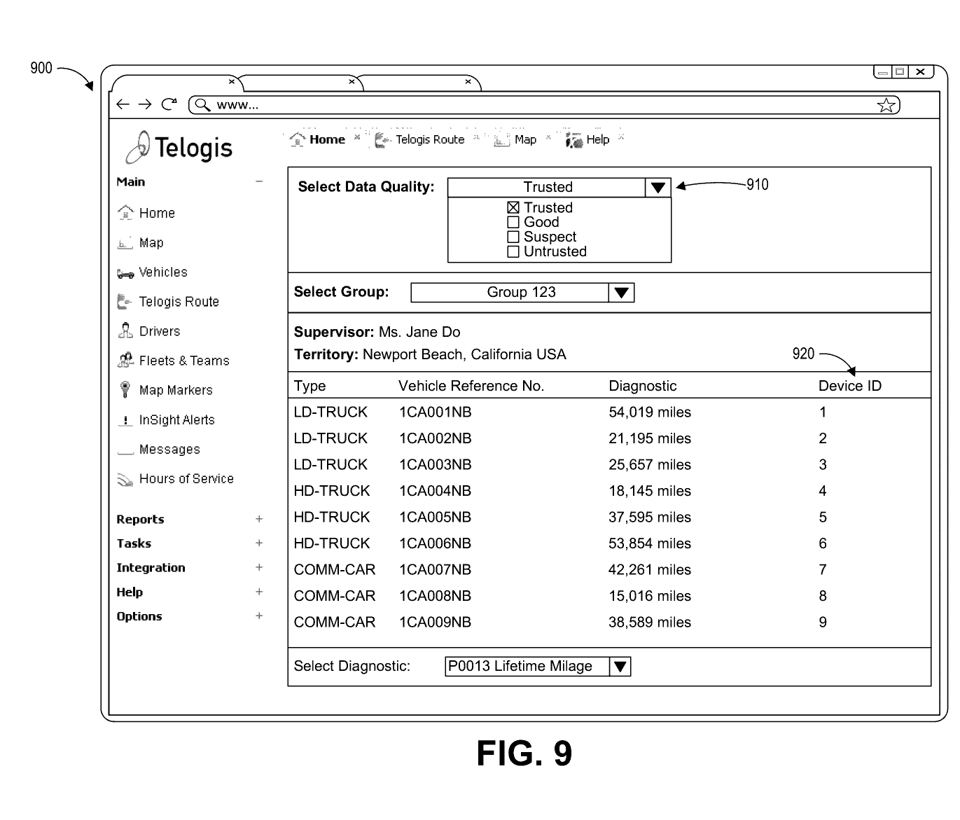

At block 608, the vehicle management system 110 or the data quality service 302 uses the determined one or more data or scores. For example, the vehicle management system 110 may filter out untrusted data by default. In the example, data associated with a score that corresponds to a particular data quality level may not be presented in a user interface, which is described with respect to the user interface 900 of FIG. 9. In some embodiments, the user interfaces of the vehicle management system 110 enable a user to select the trust level for data to be presented within a corresponding user interface. For example, if a user selects an untrusted data quality level, then the user interface of the vehicle management system 110 may only present data that has a score corresponding to an untrusted data quality level. Accordingly, the vehicle management system 110 may advantageously enable a user to troubleshoot trust issues or malfunctioning devices outputting untrustworthy data. For example, in some embodiments, the vehicle management system 110 provides user interfaces to present human readable summaries, such as text data, for why particular data received quality scores that indicate potential data quality issues. Additionally or alternatively, the user interfaces may enable a user to query the generated or processed quality data by hardware type, device identifier, entity, or vehicle identifier to further track down the source of the trust issues.

In some embodiments, the vehicle management system 110 or the data quality service 302 determines a subset of the data based at least on the determined one or more scores. As described herein, the one or more scores may correspond to various predetermined data quality levels and the vehicle management system 110 may receive or determine a particular trust level to filter data from the quality data store 320 to determine a subset of the data corresponding to the particular trust level. For example, the vehicle management system 110 receives a data quality level, which may be a default level or a user selected level, such as a trusted data quality level. The vehicle management system 110 or the data quality service 302 then determines whether the determined one or more scores corresponds to the data quality level. Examples of correspondence between the one or more scores and the data quality level include: determining that the one or more scores exceed a threshold score value; or determining that the one or more scores correspond to a predetermined threshold score value or range. For example, scores that equal 0 points may correspond to a trusted data quality level, scores that fall between the range of 1 and 4 points correspond to a good data quality level, scores that fall between the range of 6 and 9 points correspond to a suspect data quality level, and scores of 10 points above correspond to an untrusted data quality level. The vehicle management system 110 or the data quality service 302 determines or generates a subset of the data that correspond to the data quality level.

In some embodiments, the vehicle management system 110 uses the generated or processed quality data to automatically change one or more operations of the vehicle management system 110. Additionally or alternatively, the vehicle management system 110 uses the data to automatically cause one or more of the operations of a component of a vehicle, a telematics-generating component, or an in-vehicle device 104 associated with the data to be changed (for instance, by sending a command message that alters a behavior of the component or the telematics-generating component). The one or more changed operations can potentially address or remediate a quality issue and result in an improved quality of the data or performance of the corresponding device. As described herein, the one or more changed operations can include: (i) adjusting one or more settings (for instance, modes of operation, data gathering approaches, sensor sensitivities, or the like) of the vehicle management system 110, the component of the vehicle, or the telematics-generating component, (ii) installing updated operating or calibration software on the vehicle management system 110, the component of the vehicle, or the telematics-generating component, (iii) resetting the component of the vehicle or the telematics-generating component, (iv) cycling power of the component of the vehicle or the telematics-generating component, (v) displaying a message (for instance, recommendations like the quality descriptor for addressing the quality issue or to bring a vehicle in for maintenance service) on a screen of an in-vehicle device 104 associated with the measurements and values thereof, (vi) disabling the component of the vehicle or the telematics-generating component, (vii) triggering a troubleshooting software to evaluate the component of the vehicle or the telematics-generating component, (viii) adjusting a routing schedule for a vehicle associated with the measurements and values thereof (for instance, adjusting a route determined by the routing service 112 to add a maintenance service stop in place of one or more previously assigned delivery stops and reassign the one or more previously assigned delivery stops to another vehicle), (ix) ordering a new part for the vehicle management system 110, the component of the vehicle, or the telematics-generating component to attempt to address the quality issue, or (x) scheduling a maintenance appointment for a vehicle or driver associated with the measurements and values thereof.

FIG. 7 depicts example heuristics, such as quality assignment rules. The data environment 700 includes a first quality assignment rule 702, a second quality assignment rule 704, and a third quality assignment rule 708. As described herein, the heuristics, such as quality assignment rules, may be applied to data to determine one or more scores. In some embodiments, the quality assignment rules receive one or more inputs and determine a corresponding output score. As described herein, some of the inputs to the quality assignment rules may be gathered from an in-vehicle device, such as the gateway device 205. Further, the quality assignment rules may be conditional in that they output different scores based on the input variables. Additionally or alternatively, the thresholds of the quality assignment rules may be different based on the vehicle type, particular hardware type, or other input.

The first quality assignment rule 702 is an example threshold speed rule. The example first quality assignment rule 702 receives a driving distance input variable and a driving time input variable. The driving distance and driving time input variables may be gathered from an in-vehicle device, such as the gateway device 205. The example first quality assignment rule 702 includes instructions to determine a speed by dividing the driving distance by the driving time. For example, the first quality assignment rule 702 determines a speed of 100 mph by dividing a distance input of 300 miles by a time input of three hours. If the determined speed exceeds the threshold speed, then the first quality assignment rule 702 outputs a penalty score. In the example, the first quality assignment rule 702 further specifies different output penalty scores based on respective threshold speeds that are exceeded. Continuing with the example, a driving speed in excess of 100 mph receives a penalty of 10 points, a driving speed in excess of 90 mph receives a penalty of 5 points, a driving speed in excess of 85 mph receives a penalty of 3 points, and so forth. These example thresholds or output penalty scores are merely illustrative and other embodiments use different threshold values or score values, respectively.

The second quality assignment rule 704 is an example threshold idle rule. The example second quality assignment rule 704 receives an idle time input variable. As described herein, the input idle time may correspond to a period of time or a cumulative period of time where the engine of the vehicle is running but the vehicle is not moving. The example second quality assignment rule 704 includes instructions to determine whether the input idle time exceeds a threshold time. If the idle time exceeds the threshold idle time, then the second quality assignment rule 704 outputs a penalty score. Similar to first quality assignment rule 702, which assigned different output penalty scores based on different thresholds, the example second quality assignment rule 704 assigns different output penalty scores based on different idle time thresholds. For example, an input idle time exceeding 20 hours receives a penalty of 10 points, an input idle time exceeding 15 hours receives a penalty of 7 points, an input idle time exceeding 10 hours receives a penalty of 5 points, an input idle time exceeding 9 hours receives a penalty of 1 point, and so forth.

The third quality assignment rule 706 is an example threshold distance per fuel unit rule. The example third quality assignment rule 706 receives a driving distance input variable and a fuel consumption input variable (e.g., a fuel usage measurement). The example third quality assignment rule 706 includes instructions to determine a distance per fuel unit, such as miles per gallon or kilometers per liter, by dividing the driving distance by the fuel consumption. For example, the third quality assignment rule 706 determines a distance per fuel unit of 10 miles per gallon (“mpg”) by dividing a distance input of 100 miles divided by a fuel consumption input of 10 gallons. If the determined distance per fuel unit exceeds the threshold distance per fuel unit, then the third quality assignment rule 706 outputs a penalty score.

As illustrated, the example third quality assignment rule 706 further determines whether to assign a penalty score based on a vehicle type. For example, the threshold distance per fuel unit for a shipping truck may be lower than the threshold distance per fuel unit for a vehicle that has better fuel efficiency, such as a conventional gas van, electric vehicle, or other smaller vehicle. Other example vehicle types include light-duty truck (LD-TRUCK), heavy-duty truck (HD-TRUCK), and commuter car (COMM-CAR). The example third quality assignment rule 706 assigns different output penalty scores based on different vehicle types and distance per fuel unit thresholds. In the shipping truck example, a determined distance per fuel unit exceeding 12 mpg receives a penalty of 10 points, a determined distance per fuel unit exceeding 11 mpg receives a penalty of 7 points, a determined distance per fuel unit exceeding 9 mpg receives a penalty of 5 points, a determined distance per fuel unit exceeding 5 mpg receives a penalty of 1 point, and so forth. In the conventional gas van example, a determined distance per fuel unit exceeding 40 mpg receives a penalty of 10 points, a determined distance per fuel unit exceeding 35 mpg receives a penalty of 7 points, a determined distance per fuel unit exceeding 30 mpg receives a penalty of 5 points, and so forth.

In some embodiments, the vehicle type is another input to the third quality assignment rule 706. Additionally or alternatively, other quality assignment rules, such as the rules 702 and 704, may have different thresholds or instructions that are based on the vehicle type, other vehicle data, or any other data. In the threshold speed rule example, such as the first quality assignment rule 702, there may be different threshold speeds for different vehicle types. Further, in some embodiments, the thresholds of the quality assignment rules or other rule instructions are based on more granular vehicle data, such as a particular make, model, or year of the vehicle.

FIGS. 8A-8D depict example representations of vehicle data and metadata, such as one or more quality scores, that are determined by a quality assignment algorithm. In FIG. 8A, the data environment 800 includes an illustrative data set 802A. In some embodiments, the data set 802A is received from one or more vehicles through an ETL process. For example, the one or more in-vehicle devices 104, such as the gateway device 205, transmit vehicle-related data to the vehicle management system 110, which performs the ETL process. As illustrated, the initial data set 802A includes a score or quality score that is a representation of the trustworthiness of the data. In this example, quality scores initially start at 0, which corresponds to a trusted score. In other embodiments, other score values or other data representation conventions are used, such as low, medium, high, or starting at 100 instead of 0, and with 100 representing a trusted score. In some embodiments, the data sets are stored in a table and each row is associated with a quality score that indicates the trustworthiness of the row, as illustrated in the data set 802A. For example, the data set 802A may correspond to a table in a relational database.

The data set 802A includes vehicle-related data. The example data set 802A includes a data identifier or “Data ID,” which may identify each data entry or row. The example data set 802A further includes an entity identifier, such as an entity that owns or operates the vehicle, and a vehicle identifier, such as a license plate number, a vehicle identification number (“VIN”), or some other identifier. The example data set 802A also includes a device, which may correspond to a device identifier or a hardware type that is associated with the data. For example, the particular in-vehicle device or type of device that gathered or transmitted the data may be identified by the device identifier or the hardware type. The example vehicle data, such as telematics data, of data set 802A includes a driving distance, driving time, idle time, or fuel consumption of a vehicle. The data set 802A may include one or more timestamps (not illustrated). For example, the one or more timestamps may be associated with when the data was gathered.

Turning to FIG. 8B, the data environment 800 includes the data set 802B. In FIG. 8B, the example data set 802B is similar to the example data set 802A of FIG. 8A. For example, the data set 802B includes many (or all) of the same data attributes, such as columns, as the data set 802A. In the example, the data set 802B corresponds to an application of a first quality assignment rule to the original data set 802A. As illustrated, the data set 802B of FIG. 8B may correspond to the result of a first iteration of an example quality assignment algorithm applied to the original data set 802A from FIG. 8A.

The example application of the first quality assignment rule results in one or more first scores. An example first quality assignment rule is the first quality assignment rule 702 of FIG. 7, as described herein. Accordingly, the example first quality assignment rule corresponds to a threshold speed rule, which is described in further detail with respect to FIG. 7. Continuing with the example, application of the first quality assignment rule to first data, such as the Data ID 1 row, determines a speed of the corresponding vehicle by dividing the distance (300 miles) by the driving time (2 hours and 45 minutes), which corresponds to the determined speed of approximately 109 mph. Accordingly, the determined speed, 109 mph, exceeds a threshold speed, such as 100 mph, which results in assignment of a corresponding score, such as 10 points. In the example, the determined penalty score, 10 points, is added to the initial quality score, 0, which results in an updated score of 10 points. In the example, a score of 10 points or above may receive or correspond to an untrustworthy designation. In example data set 802B, metadata regarding the violation of the first quality assignment rule is stored in the “Quality History” attribute. As illustrated, a textual description of the rule violation, such as “Speed >100 mph” is stored with the first data. Additionally or alternatively to the textual description of the rule violation, a violation history identifier may be stored that associates the first data with a particular rule violation.

The example first quality assignment rule is applied to other data from the data set 802B. For example, application of the first quality assignment rule to second data, such as the Data ID 2 row, determines a speed of approximately 50 mph, which does not exceed one or more threshold speeds, so the quality score (here 0) remains the same. Continuing with another example, the first quality assignment rule is applied to third data, such as the Data ID 3 row. In the third data example, a determined speed of 91 mph exceeds a second threshold (e.g., 90 mph), which results in a second score of 5 points. Similar to the first data example, addition of the 5 point penalty score to the initial score (0 points) results in a total 5 points, which may correspond to an increased untrustworthiness state, such as a “suspect” designation. In the example, the first quality assignment rule may be applied to the remaining data of the data set 802B.

Turning to FIG. 8C, the data environment 800 includes the data set 802C. In FIG. 8C, the example data set 802C corresponds to an application of a second quality assignment rule to the data set 802B of FIG. 8B. Thus, the example data set 802C is similar to the example data set 802B of FIG. 8B. Continuing with the series of examples, the data set 802C may correspond to the results of a second iteration of the example quality assignment algorithm applied to the data set 802B from FIG. 8B.

The example application of the second quality assignment rule results in one or more second scores. An example second quality assignment rule is the second quality assignment rule 704 of FIG. 7, as described herein.

Accordingly, the example second quality assignment rule corresponds to a threshold idle rule, which is described in further detail with respect to FIG. 7. Continuing with the example, application of the second quality assignment rule to first data, such as the Data ID 1 row, determines whether the idle time of the corresponding vehicle, here 1 hour, exceeds a threshold idle time, such as 10 hours. However, according to the second quality assignment rule, there is no idling time penalty score for the first data because the idling time for the vehicle corresponding to the first data does not exceed one or more idling threshold times. Similar to the application of the second quality assignment rule to the first data, application of the second quality assignment rule to second data, such as the Data ID 2 row, does not result in a subsequent penalty score. Application of the second quality assignment rule to third data, such as the Data ID 3 row, determines whether the idle time of the corresponding vehicle, here 11 hours, exceeds a threshold idle time, such as 10 hours. Accordingly, the idle time exceeds the threshold idle time, which results in assignment of a corresponding score, such as 5 points. In the example, the determined penalty score, 5 points, is added to the previously updated quality score, 5 points, which results in a second updated score of 10 points. In the example, similar to the data ID row 3, the data ID row 4 may receive an updated score based on its respective idle time. In the example, the second quality assignment rule may be applied to the remaining data of the data set 802C.

As illustrated, the quality history metadata of the vehicle-related data may be updated. For example, the “Quality History” of the data row ID 3 may be updated to indicate that the second quality assignment rule was applied to the third data. As illustrated, the “Quality History” data is cumulative in that the previous application and determination of the first quality assignment rule to the data row ID 3 is also reflected in the quality history metadata shown in the data set 802C.

Turning to FIG. 8D, the data environment 800 includes the data set 802D. In FIG. 8D, the example data set 802D corresponds to an application of a third quality assignment rule to the data set 802C of FIG. 8C. Thus, the example data set 802D is similar to the example data set 802C of FIG. 8C. As described herein, the data set 802D may represent one or more cumulative scores for the quality of respective data items. Continuing with the series of examples, the data set 802D may correspond to the results of a third iteration of the example quality assignment algorithm applied to the data set 802C from FIG. 8C.

The example application of the third quality assignment rule results in one or more third scores. An example third quality assignment rule is the third quality assignment rule 706 of FIG. 7, as described herein. Accordingly, the example third quality assignment rule corresponds to a threshold distance per fuel unit rule, which is described in further detail with respect to FIG. 7. Continuing with the example, application of the third quality assignment rule to first data, such as the Data ID 1 row, determines a distance per fuel unit of the corresponding vehicle by dividing the distance (300 miles) by the fuel consumed (15 gallons), which corresponds to the determined distance per fuel unit of 20 mpg. In the example, the determined distance per fuel unit, 109 mph, does not exceed a threshold distance per fuel unit, such as 30 mpg. As described herein, the third quality assignment rule may be based on additional data, such as the type of vehicle. In the example, the vehicle corresponding to Data ID 1 row is a Van vehicle type and thus the third quality assignment rule did not determine a data quality violation for a distance per fuel unit of 20 mpg. Similar to the application of the third quality assignment rule to the first data, application of the second quality assignment rule to second, third, and fourth data, such as the Data ID 2, 3, and 4 rows, respectively, do not result in a subsequent penalty score.

Application of the second quality assignment rule to fifth data, such as the Data ID 5 row, determines whether a determined distance per fuel unit exceeds one or more thresholds. In the example, the vehicle corresponding to the Data ID 5 row may be a shipping truck vehicle type. Continuing with the example, application of the third quality assignment rule to the fifth data determines a distance per fuel unit by dividing the distance (102 miles) by the fuel consumed (20 gallons), which corresponds to the determined distance per fuel unit of approximately 5.1 mpg. Accordingly, the determined distance per fuel unit of the corresponding vehicle, here 5.1 mpg, exceeds a threshold distance per fuel unit, such as 5 mpg. Accordingly, the distance per fuel unit exceeds the threshold, which results in assignment of a corresponding score, such as 1 point. In the example, the determined penalty score, 1 point, is added to the initial quality score, 0, which results in an updated score of 1 point. In some embodiments, the 1 point quality score corresponds to or represents a “good” quality state of the fifth data.

The data set 802D and the corresponding scores represent the cumulative application of one or more data quality rules. The first, second, and third quality assignment rules are examples and additional rules may be applied to the data set 802D, as described herein. Moreover, the one or more scores may correspond to predetermined data quality categories. Example data quality categories include untrustworthy, suspect, good, and trusted categories. For example, the first and third data, such as Data ID rows 1 and 3, respectively, include data quality scores (here 10 points) that correspond to “untrustworthy” data; the fourth data, such as the Data ID 4 row, includes a data quality score (here 5 points) that corresponds to “suspect” data; the fifth data, such as the Data ID 5 row, includes a data quality score (here 1 point) that corresponds to “good” data; and the second data, such as the Data ID 2 row, includes a data quality score (here 0 points) that corresponds to “trusted” data. In some embodiments, the data quality categories may correspond to one or more predetermined point or value ranges. For example, untrustworthy is any point value of 10 or above, suspect is any point value between 5 and 9, good is between 1 and 4 points, and trusted is 0 points. Accordingly, the application of the one or more data quality rules result in various gradations of possible data quality that can be used by the vehicle management system 110, as described herein.

In some embodiments, the vehicle management system 100 determines and stores multiple distinct data sets, which may be similar to the data sets 802A-802D. For example, instead of a single data set or table there may be a GPS data set or table, a brakes data set or table, and so forth. Accordingly, the data quality score associated with the data sets may indicate the reliability of one or more devices associated with respective data sets. For example, if the GPS data for a particular vehicle receives poor data quality scores, then the vehicle management system 100 may be configured to filter the data for presentation through a user interface, as described herein. Further, an administrator may determine or the system may automatically determine, in some embodiments, that there is low quality data for a particular device (such as the GPS device of a vehicle), as described herein.

FIG. 9 illustrates an embodiment of a user interface 900 for using the processed or generated quality data. The user interface 900 can enable selection of a data quality level 910 that causes presentation of the underlying data that is associated with the selected data quality level. In the illustrated example, the data quality level of “Trusted” is selected, which causes trusted data to be presented by the user interface 900.

Additional details regarding the presentation and determination of the data associated with user interface 900 is described in further detail with respect to U.S. patent application Ser. No. 13/921,036, filed on Jun. 18, 2013, entitled “SYSTEM FOR PROCESSING FLEET VEHICLE OPERATION INFORMATION,” (the “'036 application”) the disclosure of which is hereby incorporated by reference in its entirety. The embodiments described herein are compatible with and/or are components of the embodiments described in the '036 application. Some or all of the features described herein can be used or otherwise combined with any of the features described in the '036 application.

As described herein, the user interface 900 may enable a user to determine or troubleshoot one or more data quality issues associated with one or more devices. A user may select a “Suspect” or “Untrusted” quality level 910 to be presented with the corresponding data to troubleshoot the data quality issues. For example, the user interface 900 includes a Device Identifier 920 that indicates the data gathering device associated with the presented data for each vehicle. Thus, by viewing “Suspect” or “Untrusted” data that is associated with particular device identifiers, hardware identifiers, or hardware types, a user may troubleshoot the source of the potential data quality problems. Additionally or alternatively, the user interface 900 includes one or more query interfaces (not illustrated) that allow a user to query quality data by hardware type, entity, or vehicle identifier to further track down the source of the trust issues.

### VII. Terminology

Any of the systems and processes described herein can be performed in real time or near real-time. As used herein, the term “real-time” and the like, in addition to having its ordinary meaning, can mean rapidly or within a certain expected or predefined time interval, and not necessarily immediately. For instance, real-time may be within a few seconds, few minutes, or 5 minutes, or 10 minutes, or some other short period of time after a triggering event.

A number of computing systems have been described throughout this disclosure. The descriptions of these systems are not intended to limit the teachings or applicability of this disclosure. For example, the user systems described herein can generally include any computing device(s), such as desktops, laptops, video game platforms, television set-top boxes, televisions (e.g., internet TVs), computerized appliances, and wireless mobile devices (e.g. smart phones, PDAs, tablets, or the like), to name a few. Further, it is possible for the user systems described herein to be different types of devices, to include different applications, or to otherwise be configured differently. In addition, the user systems described herein can include any type of operating system (“OS”). For example, the mobile computing systems described herein can implement an Android™ OS, a Windows® OS, a Mac® OS, a Linux or Unix-based OS, or the like.

Further, the processing of the various components of the illustrated systems can be distributed across multiple machines, networks, and other computing resources. In addition, two or more components of a system can be combined into fewer components. For example, the various systems described herein can be distributed across multiple computing systems, or combined into a single computing system. Further, various components of the illustrated systems can be implemented in one or more virtual machines, rather than in dedicated computer hardware systems. Likewise, the data repositories shown can represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Depending on the embodiment, certain acts, events, or functions of any of the algorithms, methods, or processes described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

Each of the various illustrated systems may be implemented as a computing system that is programmed or configured to perform the various functions described herein. The computing system may include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computing system includes multiple computing devices, these devices may, but need not, be co-located. The results of the disclosed methods and tasks may be persistently stored by transforming physical storage devices, such as solid state memory chips and/or magnetic disks, into a different state. Each process described may be implemented by one or more computing devices, such as one or more physical servers programmed with associated server code.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a” and “an” are to be construed to mean “one or more” or “at least one” unless specified otherwise.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

While the above detailed description has shown, described, and pointed out novel features as applied to various embodiments, it will be understood that various omissions, substitutions, and changes in the form and details of the devices or algorithms illustrated can be made without departing from the spirit of the disclosure. Thus, nothing in the foregoing description is intended to imply that any particular feature, characteristic, step, module, service, or block is necessary or indispensable. As will be recognized, the processes described herein can be embodied within a form that does not provide all of the features and benefits set forth herein, as some features can be used or practiced separately from others.

What is claimed is:

1. A system for determining data quality issues in a database, the system comprising:
a computer hardware processor in a physical computing device, the computer hardware processor being configured to:
receive a data set comprising first data and second data;
apply a first quality assignment rule to the first data to determine: (i) that a first value corresponding to the first data exceeds a first threshold, and (ii) a first score for the first data;
apply the first quality assignment rule to the second data to determine: (i) that a second value corresponding to the second data exceeds a second threshold, and (ii) a second score for the second data;
apply a second quality assignment rule to the first data to determine: (i) that a third value corresponding to the first data exceeds a third threshold, and (ii) an updated first score, from the first score, for the first data;
apply the second quality assignment rule to the second data to determine that a fourth value corresponding to the second data does not exceed the third threshold;
determine a subset of the data set based at least on the updated first score and the second score, wherein the subset of the data set does not include the first data; and
cause presentation, in a user interface, of the subset of the data set.

2. The system of claim 1, wherein the data set comprises vehicle telematics data.

3. The system of claim 1, wherein the computer hardware processor is configured to determine the first value from a calculation of the first data according to the first quality assignment rule.

4. The system of claim 1, wherein the computer hardware processor is configured to apply the first quality assignment rule by determining, from the first data, of at least one of: a speed, a time, a distance, a mass, a weight, an electric current, a temperature, or a luminous intensity.

5. The system of claim 1, wherein the computer hardware processor is configured determine the subset of the data set further by:
receiving a first data quality level;
determining that the updated first score does not correspond to the first data quality level;
determining that the second score corresponds to the first data quality level; and
generating the subset of the data set from the second data.

6. The system of claim 1, wherein the computer hardware processor is configured to:
apply the second quality assignment rule to the first data to determine a third score; and
determine the updated first score by adding the first score and the third score.

7. A method for determining data quality issues with fleet vehicle operation information, the method comprising:
receiving vehicle telematics data comprising first data and second data, the first data corresponding to a first vehicle and the second data corresponding to a second vehicle;
applying a first quality assignment rule to the first data to determine: (i) that a first value corresponding to the first data exceeds a first threshold, and (ii) a first score for the first data;
applying the first quality assignment rule to the second data to determine: (i) that a second value corresponding to the second data exceeds a second threshold, and (ii) a second score for the second data;
applying a second quality assignment rule to the first data to determine: (i) that a third value corresponding to the first data exceeds a third threshold, and (ii) an updated first score, from the first score, for the first data;
applying the second quality assignment rule to the second data to determine that a fourth value corresponding to the second data does not exceed the third threshold;
determining a subset of the vehicle telematics data based at least on the updated first score and the second score, wherein the subset of the vehicle telematics data does not include the first data; and
causing presentation, in a user interface, of the subset of the vehicle telematics data.

8. The method of claim 7, wherein said applying the first quality assignment rule comprises determining, from the first data, of at least one of: a driving speed, a driving time, an idle time, an amount of fuel, or a GPS coordinate.

9. The method of claim 7, wherein said applying the first quality assignment rule to the first data determines the first value, the first value corresponding to a driving distance divided by a driving time, the first threshold corresponding to a speed threshold.

10. The method of claim 7, wherein the first value corresponds to an idle time from the first data, and the first threshold corresponds to an idle time threshold.

11. The method of claim 7, wherein the first value corresponds to a fuel usage measurement from the first data, and the first threshold corresponds to a fuel usage threshold.

12. The method of claim 7, wherein said determining the subset of the vehicle telematics data comprises:
receiving a first data quality level;
determining that the updated first score does not correspond to the first data quality level;
determining that the second score corresponds to the first data quality level; and
generating the subset of the vehicle telematics data from the second data.

13. A system for determining data quality issues with fleet vehicle operation information, the system comprising:
a computer hardware processor in a physical computing device, the computer hardware processor being configured to:
receive vehicle telematics data, the vehicle telematics data comprising first data and second data;
apply a first quality assignment rule to the first data to determine: (i) that a first value corresponding to the first data exceeds a first threshold, and (ii) a first score for the first data;
apply the first quality assignment rule to the second data to determine: (i) that a second value corresponding to the second data exceeds a second threshold, and (ii) a second score for the second data;
apply a second quality assignment rule to the first data to determine: (i) that a third value corresponding to the first data exceeds a third threshold, and (ii) an updated first score, from the first score, for the first data;
apply the second quality assignment rule to the second data to determine that a fourth value corresponding to the second data does not exceed the third threshold;
determine a subset of the vehicle telematics data based at least on the updated first score and the second score, wherein the subset of the vehicle telematics data does not include the first data; and
cause presentation, in a user interface, of the subset of the vehicle telematics data.

14. The system of claim 13, wherein the computer hardware processor is configured to apply the first quality assignment rule to determine, from the first data, of at least one of: a driving speed, a driving time, an idle time, an amount of fuel, or a GPS coordinate.

15. The system of claim 13, wherein the computer hardware processor is configured to apply the first quality assignment rule to the first data to determine the first value, the first value corresponds to a driving distance divided by a driving time, and the first threshold corresponds to a speed threshold.

16. The system of claim 13, wherein the first value corresponds to an idle time from the first data, and the first threshold corresponds to an idle time threshold.

17. The system of claim 13, wherein the computer hardware processor is configured to apply the first quality assignment rule to the first data to determine the first value, the first value corresponding to a driving distance divided by a fuel usage measurement, the first threshold corresponding to a distance per fuel unit threshold.

18. The system of claim 13, wherein the computer hardware processor is configured to determine the subset of the vehicle telematics data further by:
receiving a first data quality level;
determining that the updated first score does not correspond to the first data quality level;
determining that the second score corresponds to the first data quality level; and
generating the subset of the vehicle telematics data from the second data.

19. The system of claim 13, wherein the computer hardware processor is configured to select, from a plurality of thresholds, the first threshold based at least on a vehicle type that corresponds to the first data.

20. The system of claim 13, wherein the first threshold and the second threshold are the same threshold value, and the first score and the second score are the same score value.
